(19) United States
(12) Patent Application Publication
(10) Pub. No.: US 2005/0045286 A1
(43) Pub. Date: Mar. 3, 2005

(54) Selective shading arrangement for side windows of vehicles

(76) Inventor: Walter Taehwan Kim, Los Angeles, CA (US)

Correspondence Address: Walter T. Kim, 1885 S. Oswego St., Aurora, CO, 80012, US

(21) Appl. No.: 10/647,493

(22) Filed: Aug. 25, 2003

(51) Int. Cl. B60J 1/20

(52) U.S. Cl. 160/370.21

(57) ABSTRACT

A selective shading system and method is described for providing shade for a driver or passenger of a vehicle. The selective shading system is for use with a side window assembly of a vehicle, which includes a window frame, a window movable relative to the frame and a sealing member to seal a periphery of the window. The shading system uses a shade panel to reduce transmission of light through a portion of the window. The shade panel removably attaches to the side window assembly by engaging a portion of the shade panel between an inner surface of the window and the sealing member.

### BACKGROUND

1. Field

Embodiments relate to shading arrangements for side windows of vehicles.

2. Background

Various shading systems are available to enable persons in vehicles to protect themselves from possibly harmful ultraviolet radiation coming through the side windows. For example, many commercially available shading systems use some sort of suction cups to removably attach the shading structure to a side window of a vehicle. However, there are a number of disadvantages associated with the shading systems with suction cup mounting arrangements. First, such shading system typically requires the use of both hands to properly mount it to the side window. Consequently, it may be difficult, if not impossible, for a driver to mount the shading system having suction cup mounting arrangement on a side vehicle window with just one hand while driving the vehicle with the other hand. Another disadvantage associated with the shading system having suction cup arrangement is that, after the suction cups are exposed to the hot sunlight for a long period of time, they loose their suction capability and will cause the shading structure to fall off the window.

### SUMMARY

In accordance with one embodiment of the present invention, a selective shading system and method is disclosed for providing shade for a driver or passenger of a vehicle. The selective shading system is for use with a side window assembly of a vehicle, which includes a window frame, a window movable relative to the frame and a sealing member to seal a periphery of the window. The shading system uses a shade panel to reduce transmission of light through a portion of the window. The shade panel removably attaches to the side window assembly by engaging a portion of the shade panel between an inner surface of the window and the sealing member.

### BRIEF DESCRIPTION OF THE DRAWINGS

Embodiments of the invention may be understood by referring to the following description and accompanying drawings, in which:

FIG. 1A shows a shade panel according to one embodiment of the invention.

FIG. 1B shows an inside perspective view of a front side door window assembly with the shade panel, shown in FIG. 1A, removably attached thereto.

FIG. 2 shows a section on the line A-A of FIG. 1B, illustrating the shade panel removably retained between an inner surface of a side window and a sealing member affixed to the window frame.

FIG. 3 shows an inside perspective view of a rear side door window assembly having a shade panel removably attached thereto, according to one embodiment of the invention.

FIG. 4 shows an inside perspective view of a shade panel for use with a rear side door window assembly according to another embodiment.

FIG. 5 shows an inside perspective view of a shade panel for use with a front side door window assembly according to another embodiment.

FIG. 6 shows an inside perspective view of a shade panel for use with a front side door window assembly according to yet another embodiment.

FIG. 7 shows a shade panel provided with additional layer along one or more peripheral portions of the shade panel according to one embodiment of the invention.

FIG. 8 shows a shade panel provided with gripping members along one or more peripheral portions of the shade panel portions according to one embodiment of the invention.

FIG. 9 shows a shade panel including a foldable section according to an embodiment of the invention.

FIG. 10 shows a shade panel including a bendable section according to an embodiment of the invention.

FIG. 11 shows a shade panel including a movable section according to an embodiment of the invention.

FIG. 12 shows a shade panel including a flexible shading section according to an embodiment of the invention.

### DETAILED DESCRIPTION

In the following description, specific details are set forth in order to provide a thorough understanding of the present invention. However, it will be apparent to one skilled in the art that the present invention may be practiced without these specific details. In other instances, well-known structures and techniques have not been shown in detail in order to avoid obscuring the present invention.

In certain situations, a shading arrangement is desirable to reduce or block sunlight transmitted through a portion of a side window of a vehicle. In other situations, the shading arrangement can be a nuisance and needs to be quickly removed from the side window of the vehicle. Accordingly, in accordance with embodiments of the invention, a selective shading arrangement is provided, which employs a shade panel that can be easily and quickly attached and subsequently removed from a side window of a vehicle. The shade panel may be removably attached to a side vehicle window by engaging peripheral portions of the shade panel between an inner surface of the window and a sealing member affixed to the window frame. The shade panel may be used to cover a region of a side window, when the side window is in a closed position, so as to reduce an amount of sunlight passing through the region of the side window covered by the shade panel. Subsequently, the shade panel can be easily and quickly removed from the window, for example, when the side window needs to be rolled down.

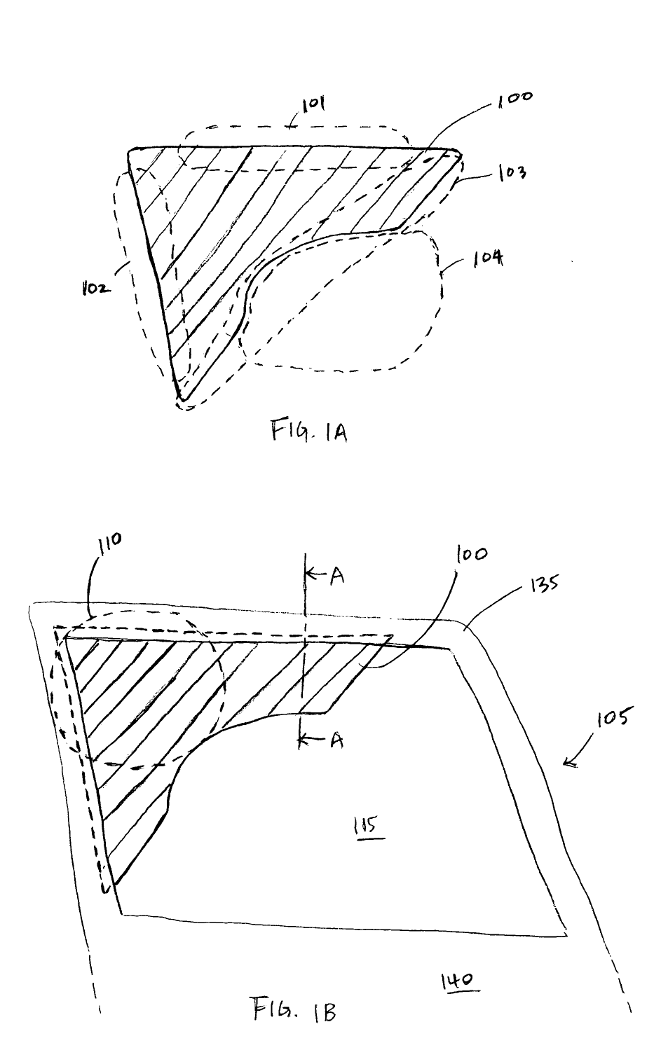

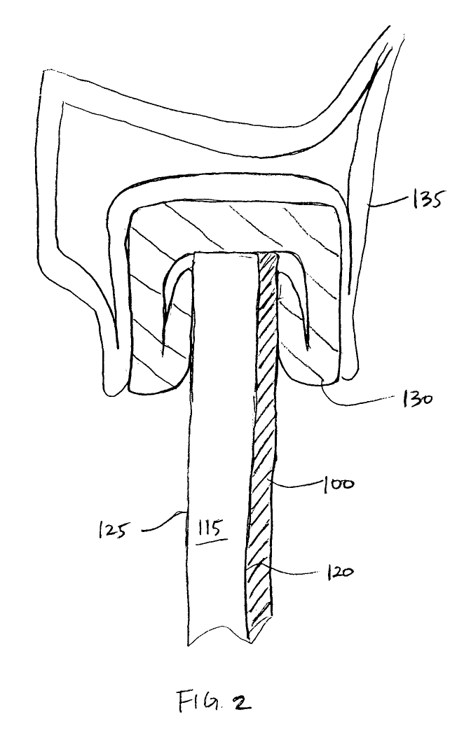

FIG. 1A shows a shade panel 100 according to one embodiment of the invention. FIG. 1B shows an inside perspective view of the shade panel 100, shown in FIG. 1A, removably attached a front side door window assembly 105. As well-known in the art, the sun-visor mounted to the ceiling of a vehicle may be rotated to block sunlight coming through the upper-front region of the front side window. However, in many vehicles, the sun-visor mounted to the ceiling is not capable of blocking sunlight coming through the upper-rear region 110 of the front side window 115. In many instances, the sunlight coming through the upper-rear region 110 of the side window 115 can be very unpleasant because the sunlight tends to project onto the sensitive facial and neck area of the person in the vehicle. If exposed for a long period of time, the long exposure to hot sunlight can be harmful and cause damage to the skin around the facial and neck area, especially for people with sensitive skins. Accordingly, as seen by referring to FIG. 1B, the illustrated shade panel 100 is shaped to cover the upper-rear region 110 of the front side window 115; the region that needs the shading the most.

Referring also to FIG. 2, which shows a section on the line A-A of FIG. 1B, illustrating a shade panel 100 removably retained between an inner surface 120 of a side window 115 and a sealing member 130 affixed to a window frame 135. The sealing member 130 is affixed to the window frame 135 and contacts a surface of the window 115, when it is in close position, to seal a periphery of the window 115. In use, the shade panel is resiliently supported between the sealing member 130 and the inner surface 120 of the window 115. It should be noted that the embodiments of shade panel 100 described herein may be used various types of sealing members 130.

As seen by referring to both FIG. 1B and FIG. 2, the front side door window assembly 105 includes a window frame 135 formed on a side vehicle door 140 and a window 115 movable relative to the window frame 135. The front side window 115 has an inner surface 120 and an outer surface 125, as shown in FIG. 2. The window frame 135 surrounds three of the four perimeter edges of the window 115. Sealing members 130 (also referred to as “weather strips”) are typically affixed to the window frame 135 of vehicles to guide the window 115 and/or provide seal between the window frame 135 and the window 115 against rainwater or the like. The illustrated shade panel 100 includes an upper peripheral portion 101, a first side peripheral portion 102 (that inclines downward) and a second side peripheral portion 103 (that inclines upward), as shown in FIG. 1. In use, the shade panel 100 is removably attached to the front side window assembly 105 by engaging the upper peripheral portion 101 and the first side peripheral portion 102 of the shade panel 100 between the inner surface 120 of the side window 115 and the sealing member 130 affixed to the window frame 135.

In the illustrated embodiment, the upper peripheral portion 101 and the first side peripheral portion 102 of the shade panel 100 is shaped to generally conform to the shape of respective region of the window 115. It should also be noted that the lower-front-side region defined by the second side peripheral portion 103 of the shade panel 100 do not conform to the shape of the window 115. Rather, the lower-side region of the shade panel 100 defined by the second side peripheral portion 103 and is shaped to minimize obstructing a view of a person in the vehicle. For example, in the illustrated shade panel 100, a portion 104 of the lower-front-side region of the shade panel 100 is cutout to minimize obstructing a view of a person in the vehicle. It should be noted that, by cutting out the portion 104 of the lower-front-side region, the overall weight of the shade panel 100 is reduced while maintaining the surface areas (defined by the peripheral portions 101 , 102) of the shade panel 100 that engages with the inner surface 120 of the window 115 and the sealing member 130. By reducing the weight of the shade panel 100 while maintaining the engagement surface area, the shade panel 100 can be better supported between the window 115 and the sealing member 130 for a longer period of time.

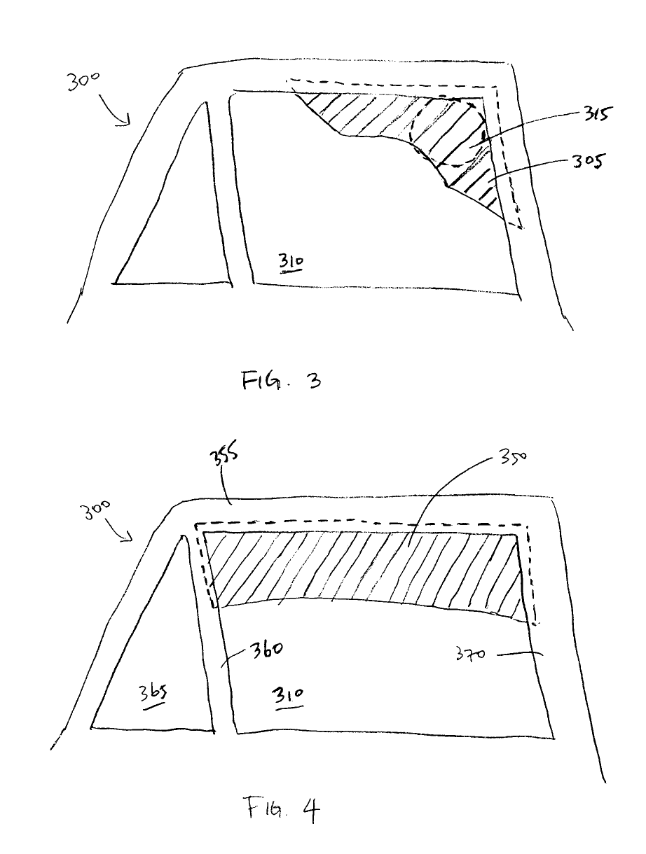

In accordance with one embodiment, the selective shading arrangement is configured for use with a rear side door window assembly 300 of a vehicle, as shown in FIG. 3. Specifically, FIG. 3 shows an inside perspective view of a rear side door window assembly 300 having a shade panel 305 removably attached thereto to reduce or block transmission of light coming through a portion of a rear side window 310, according to one embodiment. A driver or a passenger may be bothered by sunlight coming through an upper-front region 315 of the rear side window 310. Accordingly, as seen by referring to FIG. 3, the illustrated shade panel 305 is shaped to cover the upper-front region 315 of the rear side window 310.

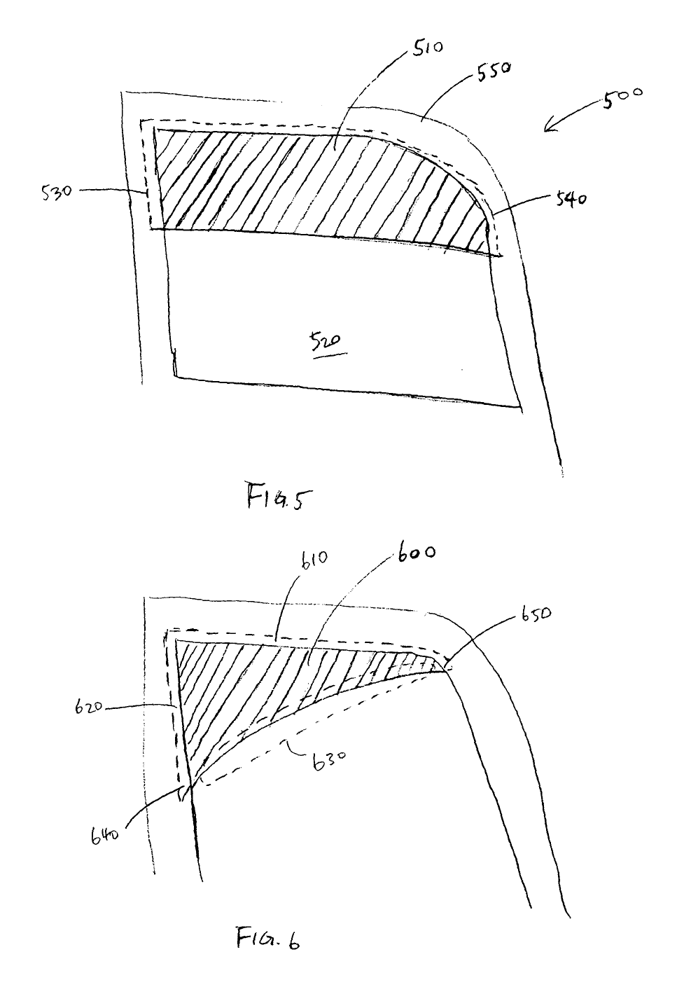

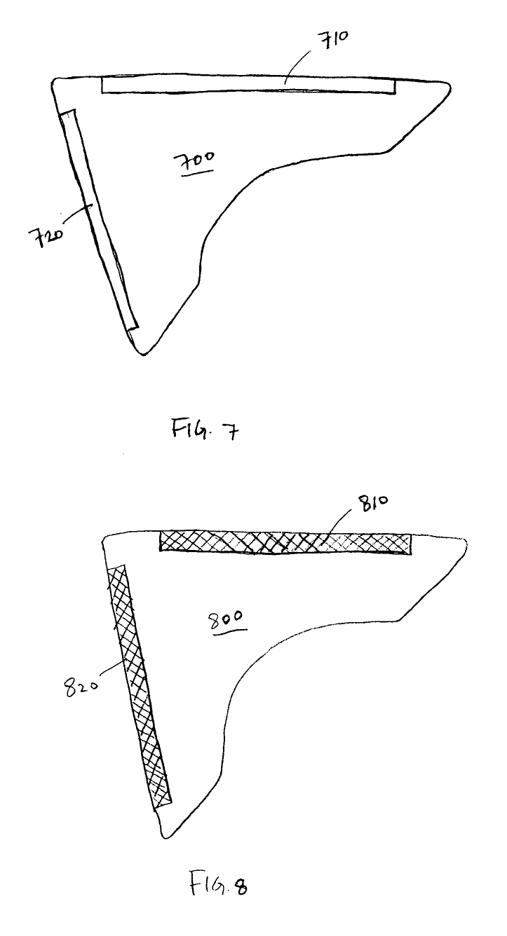

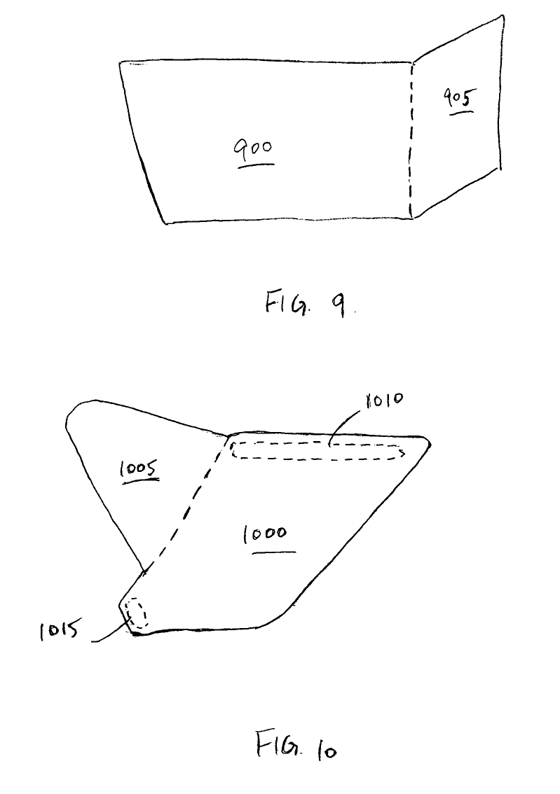

FIG. 4 shows a shade panel 350 for use with a rear side door window assembly 300 according to another embodiment. The window frame 355 of the rear side door window assembly 300 typically includes a dividing frame portion 360 separating a fixed window panel 365 and a movable window panel 310. In one embodiment, the shade panel 350 is shaped and sized to cover more than half of the upper region of the rear side window 310. In the embodiment shown in FIG. 4, the shade panel 350 is shaped and sized to extend substantially the entire length of the upper region of the rear side window 310 between the dividing frame portion 360 and the front frame portion 370 of the rear window frame 355.

In many vehicles, front and rear side windows do not have perfect 90 degrees upper corners. Rather, the angles of the upper corners of a window may be obtuse (an angle greater than a right angle) or acute (an angle less than 90 degrees). Accordingly, in one embodiment, at least one corner region of the shade panel is shaped to conform to the shape of a respective region of a side window. More specifically, at least one corner region of the shade panel is shaped to generally conform to configurations of one of upper corner regions of a side window. In one embodiment, the angle of at least one of the corners of the shape panel is acute (an angle less than 90 degrees) to conform to the shape of one of the upper corner regions of a side window, as shown in FIGS. 1A and 1B. In another embodiment, the angle of at least one of the corners of the shape panel is obtuse (an angle greater than 90 degrees) to conform to the shape of one of the upper corner regions of a side window, as shown in FIGS. 3 and 4. It should be noted that side windows of vehicles are available in various shapes and sizes. Therefore, a shade panel may be specifically shaped and sized to accommodate a group of vehicle types having similar window configuration.

FIG. 5 shows a shade panel 510 for use with a front side window assembly 500 according to another embodiment. In one embodiment, the shade panel 510 is shaped and sized to cover more than half of the upper region of the front side window 520. In the illustrated embodiment, the shade panel 510 is shaped and sized to extend substantially the entire length of the upper region of the front side window 520 from one side frame portion 530 to the other side frame portion 540 of the window frame 550. It should be noted that the shape of a shade panel is not limited to those shown in the drawings but may be modified to cover various portions of an upper region of a side window of a vehicle, for example, as shown in FIG. 6, which show a shade panel having different shape according to yet another embodiment of the invention. The shade panel 600 illustrated in FIG. 6 includes an upper peripheral portion 610 and a first side peripheral portion 620 to engage between the inner surface of a side window and a sealing member, and a second side peripheral portion 630 that generally inclines upward from one end 640 of the first side peripheral portion 620 to one end 650 of the upper peripheral portion 610.

In one embodiment, the shade panel is semi-transparent to reduce an amount of sunlight passing through a region of a side window covered by the shade panel. In one preferred embodiment, the shade panel comprises a flat panel having a relatively dark shading, i.e., capable of blocking between 75%-95% of visible light. In another preferred embodiment, the shade panel comprises a flat panel that is capable of blocking 50%-75% if visible light. In another embodiment, the shade panel is configured to block all or almost all of the sunlight from passing therethrough. In this regard, the shade panel comprises a flat panel that is capable of blocking greater than 95% of visible light.

In one embodiment, the shade panel is made of a plastic material. In context of the present disclosure, the term “panel” is used to described any flat structure, including a flat sheet made of plastic material.

In one embodiment, the entire shade panel is shaded with the same shading intensity. In another embodiment, the shade panel includes multiple shade intensities. In one implementation the shade panel is configured such that the shading provided thereon gradually changes from a dark shading (in the upper-most region) to a lighter shading (in the lower-most region). Typically, exposures to sunlight passing downward from an upper region of a side window should be avoided. Therefore, by providing a darker shading towards the top of the shade panel and a lighter shading towards the bottom of the shade panel, adequate shade may be provided to the person in the vehicle while not obstructing the view in the center and bottom regions of a side window.

As noted above, in one embodiment, an upper peripheral portion and one of the side portions of the shade panel are used to resiliently engage with the inner surface of a side window and a sealing member disposed along a window frame. In one embodiment, the thickness of the shade panel is selected such that when portions of the shade panel are engaged between the window and the sealing member, the resilient support forces of the window and the sealing member exerted on the engaged portions of the shade panel are sufficient to hold the entire shade panel. In one implementation, the entire shade panel has the same thickness. In another implementation, one or more of peripheral portions of a shade panel 700 is provided with additional layer(s) 710 and 720 so that these portions are thicker, as shown in FIG. 7. The additional layer 710 and 720 attached to engaging portions of the shade panel 700 may be helpful in cases where the gap between the inner surface of a side window and a sealing member is loose. Accordingly, the thickness of one or more peripheral portions of the shade panel 700 may be adjusted by adding layers such that these corresponding portions will fit tightly within the gap formed between the inner surface of a window and a sealing member.

In one embodiment, one or more of peripheral portions of a shade panel 800 is provided with gripping strips or gripping members 810 and 820 to provide stronger grip between a window and a sealing member, as shown in FIG. 8. Any suitable gripping material or gripping structure 810, 820 may be used to provide a sufficient gripping engagement when portions of the shade panel 800 is disposed between a window and a sealing member. In one implementation, downward shaped toothed edges are provided along a top peripheral region of the shade panel. When attached to a side window, the downward shaped toothed edges serve to grip portions of a sealing member of the window frame to provide stronger support. The toothed edges may be etched or formed direct on the shade panel.

In use, when a person in a vehicle is bothered by the sunlight passing through an upper region of a side window, the person can easily grab the shade panel and affixed to a desired window by sliding the shade panel between the inner surface of the window and the sealing member. Advantageously, the shade panel, described herein, can be attached using just one hand, even without looking at the window. Specifically, the user can simply press the shade panel gently against the side window and slide the shade panel in a desired direction until an upper peripheral portion and one of the side peripheral portion of the shade panel engages between the inner surface of the side window and the sealing member. When properly attached to the side window, the shade panel may provide shade to the face and neck area of a person in the vehicle. Such shade to the face and neck area can be particularly desirable during summer time when hot sunlight often passes through the upper region of one of the side windows. When the shading is no longer needed, the shade panel can be easily removed by pulling the shade panel away from the window frame.

The shaping of the shade panel may be accomplished in a number of different ways. For example, a desired shape may be drawn on the panel to be cut and subsequently traced with a cutting tool. The desired shape may also be drawn on a separate piece of material which is then cut and applied to the panel to be cut. A template having the desired shape may be used as a cutting guide. Using a suitable shaping technique, a flat panel is cut to a desired shape to form a shade panel for vehicle windows. In one embodiment, the shade panel is shaped such that, when the shade panel is resiliently engaged with an inner surface of a side window of a vehicle and a sealing member of a window frame, an upper peripheral portion of the shade panel engages an upper frame region of the window frame and one of the side peripheral portions of the shade panel engages a side frame region of the window frame.

In an embodiment of the invention, a shade panel 900 includes a foldable section 905, as shown in FIG. 9. In use, the foldable section 905 of the shade panel 900 may be folded and attached to a side window in a folded configuration. When a wider shading area is needed, the folded section 905 may be expanded and the shade panel 900 may be attach to the side window in the unfolded configuration.

In an embodiment of the invention, a shade panel 1000 includes a bendable section 1005, as shown in FIG. 10. In use, the bendable section 1005 of the shade panel 1000 may be bended and attached to a side window in a bended configuration. Specifically, the bendable section 1005 of the shade panel 1000 is configured to be disposed over one of the upper corner regions of the interior window frame, when the shade panel 1000 is attached to a side window assembly by engaging an upper peripheral portion 1010 and a portion of the side peripheral portion 1015 of the shade panel between an inner surface of a side window and a sealing member.

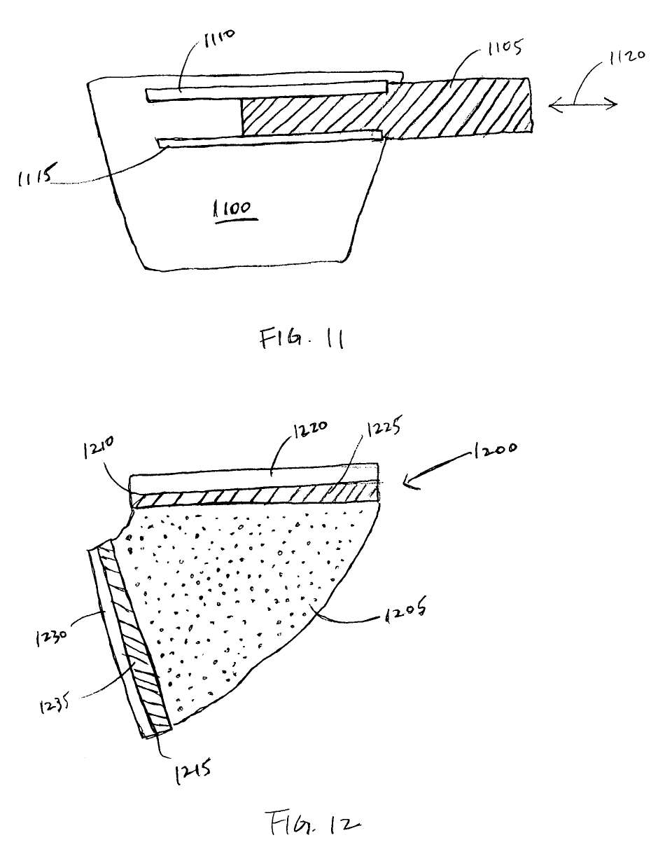

In an embodiment of the invention, a shade panel 1100 includes a movable section or a slidable section 1105, as shown in FIG. 11. In this embodiment, a sliding mechanism or a guide mechanism 1110, 1115 is provided on the shade panel 1100 to enable the movable panel 1105 to slide within the guide 1110, 1115. When desired, the movable section may be moved in a direction 1120 to provide a proper shading coverage.

In an embodiment of the invention, a shade member 1200 having a shading section 1205 made of a flexible material, as shown in FIG. 12. The shade member 1200 includes a first section 1210 for removably attaching to an upper frame region of a window frame and a second section 1215 for removably attaching to a side frame region of the window frame. Coupled between the first section 1210 and second section is a shading section 1205 to reduce transmission of light therethrough. The first section 1210 includes a first portion 1220 configured to engage between an inner surface of a side window and a sealing member and a second portion 1225 for engaging one of the edge regions of the shading section 1205. Similarly, the second section 1215 includes a first portion 1230 configured to engage between an inner surface of a side window and a sealing member and a second portion 1235 for engaging one of the edge regions of the shading section 1205. In one implementation of this embodiment, the first and second sections 1210, 1215 of the shade member 1200 are made of semi-rigid or rigid plastic material and the shading section 1205 is made of a flexible material. Such arrangement enables the shade member 1200 to be folded or rolled so that it can be stored in a relative small area .

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

1. A sunshade for use with a side window assembly of a vehicle, the side window assembly including a window frame, a window movable relative to the frame and a sealing member to seal a periphery of the window, the sunshade comprising:
a shade panel to reduce an amount of light passing through a portion of the window, the shade panel to removably attach to the side window assembly by engaging a portion of the shade panel between an inner surface of the window and the sealing member.

2. The sunshade of claim 1, wherein the shade panel removably attaches to the side window assembly by engaging an upper peripheral portion and a first side peripheral portion of the shade panel between the inner surface of the window and the sealing member.

3. The sunshade of claim 2, wherein the upper peripheral portion and the first side peripheral portion of the shade panel are shaped and sized to generally conform to shape of one of upper corner regions of the window.

4. The sunshade of claim 1, wherein one of upper corner regions of the shade panel has an angle that is less than 90 degrees to substantially conform to one of upper corner regions of the window.

5. The sunshade of claim 1, wherein one of upper corner regions of the shade panel has an angle that is greater than 90 degrees to substantially conform to one of upper corner regions of the window.

6. The sunshade of claim 2, wherein the shade panel further includes a second side peripheral portion that generally inclines upward from one end of the first side peripheral portion to one end of the upper peripheral portion.

7. The sunshade of claim 1, wherein the shade panel comprises a flat panel that is capable of blocking between 75%-95% of visible light.

8. The sunshade of claim 1, wherein the shade panel comprises a flat panel that is capable of blocking greater than 95% of visible light.

9. The sunshade of claim 1, wherein the shade panel is made of a plastic material.

10. A system comprising:
a side window assembly for a side door of a vehicle, the side window assembly including a window frame, a window movable relative to the frame and a sealing member coupled to the window frame to seal a peripheral of the window; and
a shade member capable of reducing an amount of light transmitted therethrough, the shade member including a first section to removeably couple to an upper frame region of the window frame between the inner surface of the side window and the sealing member and a second section to removably couple to a side frame region of the window frame between the inner surface of the side window and the sealing member.

11. The system of claim 10, wherein the shade member includes a third section coupled between the first section and the second section to reduce transmission of light therethrough.

12. The system of claim 11, wherein the third section has different thickness than the first and second sections.

13. The system of claim 12, wherein the third section is made of flexible material.

14. The system of claim 12, wherein the first and second sections are made of semi-rigid or rigid plastic material.

15. A method comprising:
providing a structure capable of reducing an amount of light transmitted therethrough;
sliding the structure along an inner surface of a side window of a vehicle; and
engaging a first peripheral portion of the structure between the inner surface of the side window and a sealing member portion affixed to an upper frame portion of a window frame.

16. The method of claim 15, further comprising engaging a second peripheral portion of the structure between the inner surface of the side window and a sealing member portion affixed to a first side frame portion of the window frame.

17. The method of claim 15, wherein the structure comprises a shade panel having at least one upper corner shaped to substantially conform to an upper-rear corner region of the side window of a front side door of the vehicle.

18. The method of claim 15, wherein the structure comprises a shade panel having at least one upper corner shaped to substantially conform to an upper-front corner region of the side window of a rear side door of the vehicle.

19. A method comprising:
providing a structure capable of reducing an amount of light transmitted therethrough; and
shaping the structure such that, when the structure is resiliently engaged between an inner surface of a side window of a vehicle and a sealing member of a window frame, a first peripheral portion of structure engages an upper frame region of the window frame and a second peripheral portion of the structure engages a side frame region of the window frame.

20. The method of claim 19, further comprising:
shaping the structure such that a corner region defined by the first peripheral portion and the second peripheral portion of the structure substantially conforms to a upper corner region of a side window of a vehicle.

21. The method of claim 20, further comprising reducing an amount of sunlight passing through an upper region of the side window of the vehicle by engaging the first peripheral portion of the shaped substrate between the inner surface of the side window and the sealing member along the upper frame portion of the window frame.

22. The method of claim 20, wherein the corner region defined by the first peripheral portion and the second peripheral portion of the structure has an angle that is less than 90 degrees to substantially conform said one of upper corner regions of the window frame.

23. The method of claim 20, further comprising shaping a region of the structure opposite to the first peripheral portion and the second peripheral portion such that when the substrate is attached to the side window, the substrate does not obstruct a view of a person in the vehicle.

24. The method of claim 20, wherein the substrate comprises a flat panel having a degree of transparency in a range of 5% to 30%.

25. The method of claim 20, wherein the substrate comprises a flat panel made of a plastic material.

26. A shade structure comprising:
an upper peripheral region to engage between an inner surface of a window and a sealing member to seal an upper periphery of the window;
a first side peripheral region to engage between the inner surface of the window and the sealing member to seal a first side periphery of the window; and
a shading region provided between the upper peripheral region and the first side peripheral region.

27. The shade structure of claim 26, wherein at least a portion of the upper peripheral region is provided with a gripping member to provide stronger grip between the inner surface of the window and the sealing member,

28. The shade structure of claim 26, wherein at least a portion of the upper peripheral region is thicker than the shading region.

29. The shade structure of claim 26, wherein the shade region is shaded with multiple shade intensities.

30. The shade structure of claim 26, wherein the shading region further includes a foldable section.

31. The shade structure of claim 26, wherein the shading region further includes a bendable section.

32. The shade structure of claim 26, wherein the shading region further includes a movable section.
